(19) United States
(12) Patent Application Publication
(10) Pub. No.: US 2002/0166269 A1
(43) Pub. Date: Nov. 14, 2002

(54) Method for marking packages for graphic processing

(75) Inventor: Peter Merkli, Oftringen (CH)

Correspondence Address: Friedrich Kueffner, Suite 1921, 342 Madison Avenue, New York, NY, 10173, US

(73) Assignee: Muller Martini Holding AG

(21) Appl. No.: 10/138,961

(22) Filed: May 3, 2002

(30) Foreign Application Priority Data
May 14, 2001 (EP) 01810467.9-2304

(51) Int. Cl. G09F 3/10

(52) U.S. Cl. 40/299.01; 40/638

(57) ABSTRACT

In a method for marking or identifying packages of products for graphic processing, a carrier is arranged on the package and the carrier is provided with information in regard to the contents of the package. The carrier is a display. Visually readable data and machine-readable data are written on the display.

### BACKGROUND OF THE INVENTION

1. Field of the Invention

The invention relates to a method for marking or identifying packages of products of graphic processing, wherein a carrier is arranged on these packages and is provided with data in regard to the contents of the package. The invention also relates to a package for graphic processing.

2. Description of the Related Art

In the graphics industry, numerous types of different packages are used for processing printed products and semi-finished printed products. For example, such packages are bundles, palettes, paper stacks or rolling stands. The printed products or semi-finished printed products are transported in the form of such packages from one processing station to another or to a shipping station. Such packages must generally be marked. Such a marking or identification is designed particularly for specifying the contents of the package. In addition, such a marking or identification can also provide information in regard to the support of the package, for example, a rolling stand. The data relate to, for example, the type of the products, the number of the products, the printing date, the client, or a delivery address for shipping these packages.

In the past, the carrier for the aforementioned marking or identification has been a simple slip onto which the desired information is to be applied in a visually readable form or also in the form of a bar code. The slips are attached to the package, for example, by gluing and removed when needed. When a large number of packages is to be marked, handling of a correspondingly large number of slips is very complex. Also, an automated processing has been found to be comparatively complex.

Instead of using slips, it is also known to employ transponders which are provided with the required information. These transponders can be read with suitable devices which, of course, simplifies automated processing. A disadvantage, however, is that the information contained in the transponder cannot be visually recognized. Therefore, a suitable device must be present at all times in order to be able to read the transponder attached to the package.

### SUMMARY OF THE INVENTION

It is an object of the present invention to provide a method of the aforementioned kind which enables a simplified marking or identification of packages for graphic processing. The method should be performable substantially automatically and should be able to convey intelligible information without a reading device.

In accordance with the present invention, this is achieved in that the carrier is a display.

The term display in the context of the invention is to be understood as an electronic indicating device which has a display field for a changeable visual data indication and which can be written on and read by a suitable device. A change of the inscription is possible at any time. Information can be corrected, supplemented, or deleted. This is also possible without problems in a wireless way and can be realized by a central writing unit. A significant advantage of the method according to the invention and of the package according to the invention resides in that at least one part of the information can be visually recognized. When, for example, information in regard to the contents is required for handling such a package, this information can be read easily on the display without using a special reading device. In spite of this, the aforementioned correction and changes of the inscription and of the information are possible easily in an automated or electronic way. Handling and manipulation of the marking of packages are therefore enabled without disadvantages in an automated way and very efficiently.

According to one embodiment of the invention, such a display contains at the same time visually readable information and information that is only machine-readable. The display contains thus a part of the information as a visually readable inscription and another part of the information as electronically stored information. Accordingly, the visually readable inscription can be limited to the important data. The electronically stored and only machine-readable information can contain data which must not necessarily be visually recognizable or should not be visually recognizable. The display can contain, for example, information in the form of a bar code. It is known that such a bar code is only machine-readable. The desired information can thus be written in conventional form which can be recognized without a reading device, but a very efficient machine-based processing is possible also.

According to a further embodiment of the invention, the display is an electronic paper or electronic film. Such displays are known in the art. They are suitable for this application because they are inexpensive and can be attached similar to the way slips are attached to the package. They can be controlled by organic circuits. They are particularly suitable for the identification of a package because they can be used similar to the aforementioned slips or a label. They have the additional advantage that they can be repeatedly used and that they can be electronically corrected, supplemented, and deleted. Instead of electronic paper or an electronic film, it is also possible to use a known liquid crystal display as the display.

### BRIEF DESCRIPTION OF THE DRAWING

In the drawing:

FIG. 1 show schematically a package of the present invention; and

FIG. 2 shows schematically a display.

### DESCRIPTION OF THE PREFERRED EMBODIMENTS

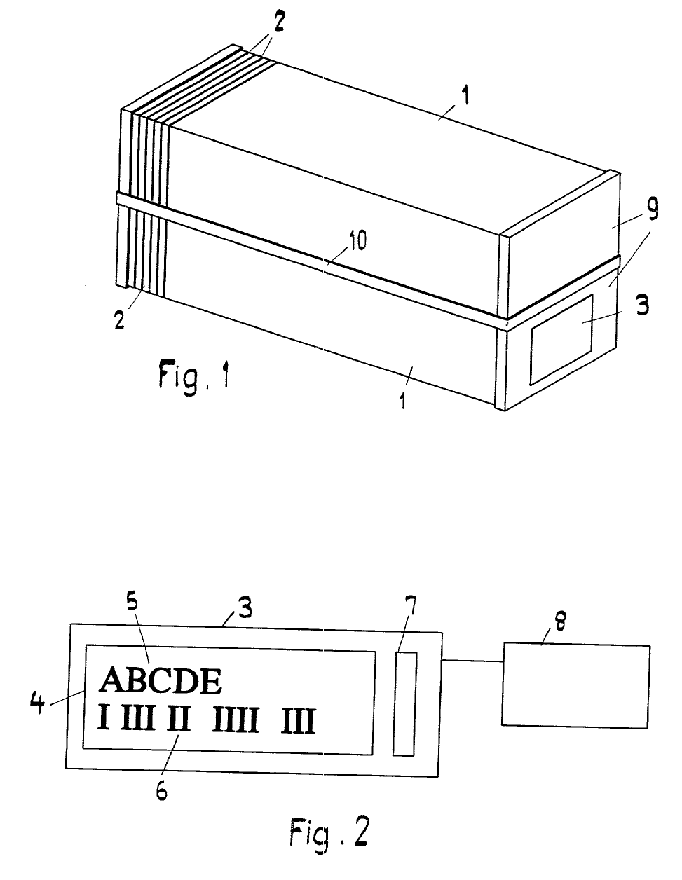

FIG. 1 shows a package 1, which is a so-called stack comprising a plurality of printed products 2 or such semi-finished printed products which are banded and secured by means of two end plates 9 as is known in the art. The printed products 2 or, for example, printed sheets, brochures, newspapers, magazines, or the like. The package 1 can also be, for example, embodied as a pallet, a bundle, a roll or the like.

On one or both end plates 9 a carrier in the form of a display 3 is attached on the exterior. The attachment of the display 3 on the end plates 9 can also be such that the display 3 is detachable or exchangeable. For example, the display 3 is inserted into a separate holder, not illustrated. The display 3 can also be glued onto the end plates 9 or, for example, can be detachably connected by means of hook-and-loop strips.

According to FIG. 2, the display 3 has a display field 4 which is, for example, formed by a liquid crystal display known in the art. The display 3 is controlled by a circuit 8 which enables writing on the display field 4, changing the inscription or deleting it. This can be realized in a wireless way with devices well known in the art. For example, a visually readable text or inscription 5 can be written on the display field 4. The text 5 contains, for example, information in regard to the type of the printed products 2, their number, a date and/or an address for delivery of the package 1. The display field 4 can contain also a bar code 6 which is machine-readable as is known in the art. Further, the display 3 can be provided with a storage means 7 which contains electronic information which can be written into the storage means 7 and changed only by a corresponding device. The display 3 can also be formed by known electronic paper or known electronic films or foils, and the circuit 8 can be an organic circuit. The organic circuit 8 forms a unit together with the display 3. The display 3 with the integrated organic circuit 8 can be flexible and glued like a slip onto the package 1 or attached thereto in any other adhering way. The information of the text or inscription 5 or pictograph can be visually recognized and understood at any time without a particular reading device. For example, this text 5 is an address which provides the delivery location of the package 1. The bar code 6 contains, for example, information which must not necessarily be recognizable visually but can be read by a known device. The storage device 7 can contain moreover information which is accessible, for example, only by the owner of the package 1. The display 3 enables thus to process information in different ways. Preferably, all information can be changed and replaced. It is also possible that the storage device 7, contains information which cannot be deleted.

While specific embodiments of the invention have been shown and described in detail to review of the carrier illustrate the inventive principles, it will be understood that the invention may be embodied otherwise without departing from such principles.

What is claimed is:

1. A method for marking or identifying packages of products for graphic processing, wherein the method comprises the steps of:
arranging a carrier on a package; and
providing the carrier with information in regard to the contents of the packages wherein the carrier is a display.

2. The method according to claim 1, wherein visually readable data are written on the display.

3. The method according to claim 2, wherein machine-readable data are written on the display.

4. The method according to claim 1, wherein machine-readable data are written on the display.

5. The method according to claim 1, wherein the display is detachably connected to the package.

6. The method according to claim 1, wherein the display is comprised of electronic paper.

7. The method according to claim 1, wherein the display is comprised of electronic film.

8. The method according to claim 1, further comprising the step of controlling the display by an organic circuit.

9. The method according to claim 1, wherein the package is a bundle, a pallet, or a stack.

10. The method according to claim 1, wherein the package comprises a rolling stand.

11. A package for graphic processing, comprising a carrier for marking the package, wherein the carrier is a display and contains data in regard to the contents of the package.

12. The package according to claim 11, wherein the display contains visually readable data.

13. The package according to claim 12, wherein the display contains machine-readable data.

14. The package according to claim 11, wherein the display contains machine-readable data.

15. The package according to claim 11, wherein at least a portion of the data is machine-processable.

16. The package according to claim 11, wherein the data is imputable, readable, and changeable.

17. The package according to claim 11, wherein the display is comprised of electronic paper.

18. The package according to claim 11, wherein the display is comprised of electronic film.

19. The package according to claim 11, comprising printed products.

20. The package according to claim 11, comprising semi-finished printed products.
